(19) United States
(12) Patent Application Publication
(10) Pub. No.: US 2023/0086495 A1
(43) Pub. Date: Mar. 23, 2023

(54) METHOD FOR DETERMINING A CHARACTERISTIC ASSOCIATED WITH A PORTION OF A PATH OF AN AIRCRAFT

(71) Applicant: Airbus SAS, BLAGNAC (FR)

(72) Inventor: Benoit SALGUES, BLAGNAC (FR)

(21) Appl. No.: 17/940,095

(22) Filed: Sep. 8, 2022

(30) Foreign Application Priority Data
Sep. 21, 2021 (FR) 2109890

(51) Int. Cl. G01C 21/20

(52) U.S. Cl. CPC G01C 21/20

(57) ABSTRACT

A method for determining a characteristic associated with a portion of a path of an aircraft includes the following steps, implemented by a processing unit of a computer: acquiring timestamped information relating to points of the path of the aircraft; selecting an interval of successive points of the path, corresponding to the portion of the path; selecting a first predetermined number of subsets of points belonging to the interval of points; determining a value of the characteristic for each subset of points; and determining a value of the characteristic for the interval of points, based on the values of the characteristic that are determined for each subset of points.

### CROSS-REFERENCES TO RELATED APPLICATIONS

This application claims the benefit of the French Patent Application No. 2109890 filed on Sep. 21, 2021, the entire disclosures of which are incorporated herein by way of reference.

### FIELD OF THE INVENTION

The invention relates to the field of determining paths of aircraft based on information stored in a database.

### BACKGROUND OF THE INVENTION

In particular, for a given path of an aircraft, it may be desirable to determine, at a point of interest of the path, a characteristic associated with the path, this characteristic being such as, for example, a heading of the aircraft, an anticipated runway, a turning radius of the aircraft, a horizontal or vertical speed, etc. The majority of modern aircraft are equipped with an ADS-B (“Automatic Dependent Surveillance - Broadcast”) transponder that regularly broadcasts, on a radio communication frequency, information relating to the transmitting aircraft, such as for example its identification, its position, its speed, etc. This information may be received by nearby aircraft or by ground stations (air traffic control, etc.), which are thus aware of the situation of the aircraft transmitting the information. There are some ground stations that collect ADS-B information transmitted by aircraft flying close to the ground stations and that transmit this information, accompanied by a timestamp added by the ground station, to a platform that centralizes and stores the timestamped information in a database. The information stored in such a database makes it possible to be aware of global aircraft traffic, in particular the paths of the aircraft. However, many ground stations that transmit ADS-B information to the platform might not be perfectly set to the same time. Given that the timestamping of the information originates from the ground stations, this may lead to asynchronism in the information stored in the database. Thus, for information stored in the database corresponding to a path of an aircraft, the chronological order of the information (corresponding to the timestamping thereof) might not correspond to the actual chronological order of the passage of the aircraft across various points of the path corresponding to this information stored in the database. This may, therefore, result in a difficulty for a user in reliably determining a characteristic associated with the path.

### SUMMARY OF THE INVENTION

The present invention aims, in particular, to provide a solution to this problem. It relates to a method for determining a characteristic associated with a portion of a path of an aircraft, the method comprising the following step, implemented by a processing unit of a computer:

acquiring, from a database, timestamped information relating to points of a path of the aircraft.

The method is noteworthy in that it furthermore comprises the following steps, implemented by the processing unit of the computer:
selecting, from among the points of the path corresponding to the information acquired from the database, an interval of successive points of the path of the aircraft, this interval of points corresponding to the portion of the path;
selecting a first predetermined number of subsets of points belonging to the interval of points, these subsets being mutually different, each subset of points comprising a second predetermined number of points, the first predetermined number being greater than or equal to three and the second predetermined number corresponding to a number of points needed and sufficient to determine the characteristic;
determining a value of the characteristic for each subset of points;
determining a value of the characteristic for the interval of points, based on the values of the characteristic that are determined for each subset of points.

The method thus makes it possible to improve the reliability of determining the characteristic associated with the path of the aircraft, insofar as this characteristic is determined based on values of the characteristic that are determined for at least three mutually different subsets of points of the path. The fact that the points of the subsets of points belong to an interval of points corresponding to the portion of the path makes it possible to reduce the influence of an asynchronism in relation to information associated with a point of the path.

According to one particular embodiment, the interval of successive points comprises the following points:
a first set of points comprising a number of points equal to the second predetermined number of points, including a point of interest of the path for which it is desired to determine the characteristic;
a third predetermined number of points before the first set of points in the order of the timestamping of the information from the database; and
a fourth predetermined number of points after the first set of points in the order of the timestamping of the information from the database.

In particular, the third predetermined number of points and the fourth predetermined number of points are equal.

Advantageously, the various points of the interval of points correspond to consecutive points in the order of the timestamping of the information from the database.

Again advantageously, to determine the value of the characteristic for each subset of points, the various points of each subset of points are ordered in the order of the timestamping of the information from the database.

According to a first alternative, the various points of each subset of points are selected from among the points belonging to the interval of points by implementing a pseudo-random draw algorithm.

According to another alternative, the various points of each subset of points are selected in a predetermined manner from among the points belonging to the interval of points.

In one embodiment, the characteristic is chosen from among the following set of features:
a characteristic relating to an attitude or to a position of the aircraft, or to variations in an attitude or in a position of the aircraft;
a characteristic relating to the evolution of the aircraft in its environment;
a characteristic relating to a maneuver of the aircraft;
a characteristic derived from the above characteristics.

Advantageously, the value of the characteristic for the interval of points is determined as corresponding to:
a median of the values of the characteristic that are determined for each subset of points, when the characteristic is numerical; or
a majority vote from among the values of the characteristic that are determined for each subset of points when the characteristic is non-numerical.

In one particular embodiment, the method furthermore comprises a step of determining a confidence indicator associated with the value of the characteristic determined for the interval of points.

### BRIEF DESCRIPTION OF THE DRAWINGS

The invention will be better understood upon reading the following description and upon studying the appended figures.

FIG. 1 is a simplified view of an aircraft.

FIG. 2 schematically illustrates a system intended to implement a method for determining a characteristic associated with a portion of a path of an aircraft, according to one embodiment of the invention.

FIG. 3 illustrates a portion of a path of an aircraft.

FIG. 4 illustrates a method for determining a characteristic associated with a portion of a path of an aircraft, according to one embodiment of the invention.

### DETAILED DESCRIPTION OF THE PREFERRED EMBODIMENTS

The system 10 shown in FIG. 2 comprises a computer 14 that comprises a processing unit 15. The computer 14 is connected at an input to a database 12 that contains timestamped information relating to points of paths of aircraft. The computer 14 is also connected at an output to a user device 18. Without limitation, the user device 18 may correspond to a computer separate from the computer 14 or else to a human/machine interface, such as a display screen, of the computer 14.

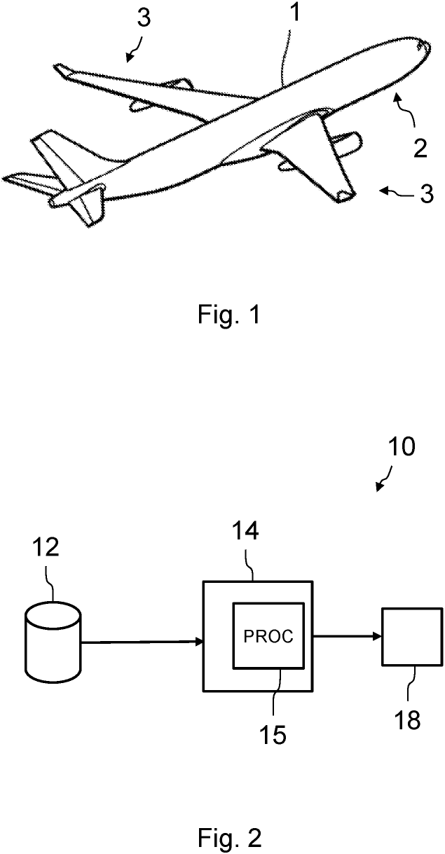

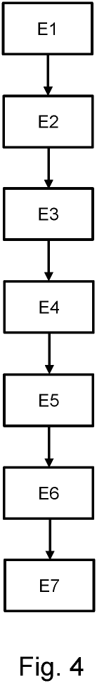

During operation, in a step E1 of a method according to the invention as illustrated in FIG. 4, the processing unit 15 acquires, from the database 12, timestamped information relating to points of a path of an aircraft, such as for example the aircraft 1 illustrated in FIG. 1. This aircraft comprises a fuselage 2 and wings 3. In a step E2, the processing unit 15 selects, from among the points of the path of the aircraft corresponding to the information acquired from the database 12, an interval of successive points of the path. This interval of points corresponds to a portion of the path of the aircraft for which it is desired to determine a characteristic associated with this portion of the path. In a step E3, the processing unit selects a first predetermined number k of subsets of mutually different points belonging to the interval of points. The number k of subsets of points is greater than or equal to three. Each subset of points comprises a second predetermined number s of points. This number s corresponds to a number of points needed and sufficient to determine the characteristic associated with the portion of the path. In a step E4, the processing unit determines a value of the characteristic under consideration for each of the k subsets of points. For this purpose, the points of each subset of points are considered in a chronological order corresponding to the timestamping of the points from the database 12. Next, in a step E5, the processing unit determines a value of the characteristic for the interval of points based on the values of the characteristic that are determined for each subset of points. Advantageously, in a step E6, the computer 14 transmits the value of the characteristic determined for the interval of points to the user device 18.

According to one possibility, the characteristic associated with the portion of the path is a characteristic relating to an attitude or to a position of the aircraft, or to variations in an attitude or in a position of the aircraft. The characteristic then corresponds, for example, to a heading, a turning radius, an altitude, a height, a flight level, a speed vector or a component of a speed vector, an acceleration vector or a component of an acceleration vector of the aircraft, etc. According to another possibility, the characteristic associated with the portion of the path is a characteristic relating to the evolution of the aircraft in its environment. The characteristic then corresponds, for example, to a departure or arrival airport for the aircraft, to a runway used for a takeoff or a landing of the aircraft, a taxiway used for taxiing of the aircraft, a boarding gate corresponding to the parking of the aircraft, etc. According to yet another possibility, the characteristic associated with the portion of the path is a characteristic relating to a maneuver of the aircraft. The characteristic then corresponds, for example, to a start or to an end of an acceleration, a takeoff, a landing, a braking operation, taxiing or towing of the aircraft, etc. These various possibilities do not limit the characteristic associated with the portion of the path. This characteristic may, for example, also correspond to a characteristic derived from the abovementioned characteristics.

In one particular embodiment, the interval of successive points of the path consists of the following points:
a first set of points comprising a number of points equal to the second predetermined number s of points, including a point of interest of the path for which it is desired to determine the characteristic;
a third predetermined number n1 of points before the first set of points in the order of the timestamping of the information from the database; and
a fourth predetermined number n2 of points after the first set of points in the order of the timestamping of the information from the database.

The interval of points thus comprises points that surround the point of interest of the path for which it is desired to determine the characteristic. Advantageously, the third predetermined number n1 and the fourth predetermined number n2 are each greater than or equal to two.

In particular, the third predetermined number n1 and the fourth predetermined number n2 are equal. Again in particular, the various points of the interval of points correspond to consecutive points in the order of the timestamping of the information from the database.

The second predetermined number s of points needed and sufficient to determine the characteristic associated with the portion of the path is for example equal to two when the characteristic corresponds to a heading of the aircraft. This number s is for example at least equal to three when the characteristic corresponds to a turning radius of the aircraft.

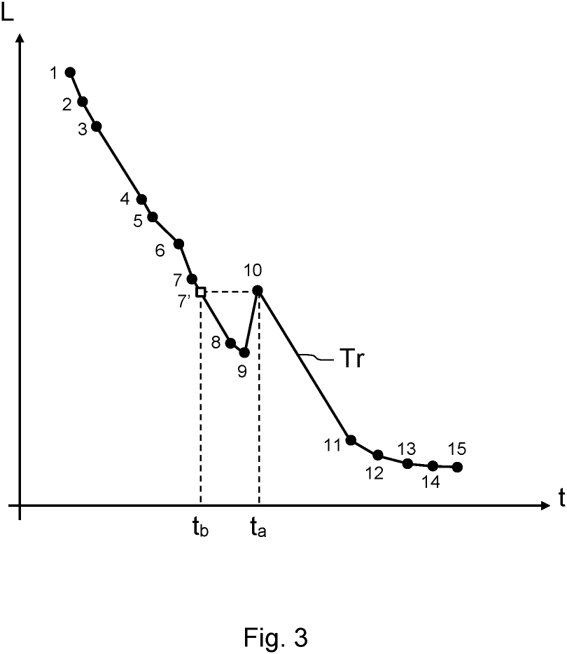

The example of a path of an aircraft illustrated in FIG. 3 corresponds to timestamped information from the database 12. This timestamped information comprises the latitude and the longitude of the aircraft at various waypoints numbered 1 to 15 in ascending chronological order of the timestamping. To simplify the example, only latitude L is shown in the figure, as a function of time t. Longitude is considered to be constant for the various points under consideration. It is considered that the characteristic that it is desired to determine corresponds to the heading of the aircraft. Except between points 9 and 10, the latitude L decreases between a point of the path illustrated in the figure and the following point of the path. This corresponds to a path of the aircraft oriented from North to South, that is to say, a heading equal to 180°. Due to a problem with the timestamping of the information contained in the database 12 for point 10, the latitude L increases between points 9 and 10. This corresponds to a path of the aircraft oriented from South to North, that is to say, a heading equal to 0°. Due to the abovementioned timestamping problem, the information relating to point 10 is timestamped in the database 12 at a time ta. However, in the absence of any timestamping problem, point 10 should have corresponded to an intermediate point 7' between points 7 and 8, timestamped at a time tb.

To implement a method according to the invention in the abovementioned exemplary scenario, given that the characteristic that it is desired to determine corresponds to the heading of the aircraft, the second predetermined number s is chosen to be equal to two. The third predetermined number n1 and the fourth predetermined number n2 are each chosen to be equal to two. When it is desired to determine the heading of the aircraft associated with a portion of the path Tr comprising point 10, the interval of successive points of the path consists of the following points:
a first set of points comprising two points (second predetermined number s of points), including the point of interest 10 of the path for which it is desired to determine the characteristic. This first set of points comprises, for example, points 10 and 11;
two points (third predetermined number n1) before the first set of points in the order of the timestamping of the information from the database, that is to say, points 8 and 9; and
two points (fourth predetermined number n2) after the first set of points in the order of the timestamping of the information from the database, that is to say, points 12 and 13.

Therefore, the set of points selected in step E2 consists of six points (8, 9, 10, 11, 12, 13).

The first predetermined number k of subsets of points is, for example, chosen to be equal to 3. Given that the second predetermined number s corresponds to two points, step E3 corresponds to the selection of three subsets of points each comprising two points. According to a first alternative, the various points of each subset of points are selected from among the points belonging to the interval of points by implementing a conventional pseudo-random draw algorithm. According to another alternative, the various points of each subset of points are selected in a predetermined manner from among the points belonging to the interval of points. The way in which the points are selected is then predetermined regardless of which points belong to the interval of points: for example, a first subset comprises the first and the fifth points of the set of points, a second subset comprises the second and the third points of the set of points and the third subset comprises the fifth and the sixth points of the set of points. Thus, in the abovementioned example, the first subset comprises the points (8, 12), the second subset comprises the points (9, 10) and the third subset comprises the points (12, 13). In step E4, the processing unit determines a value of the characteristic (corresponding to the heading of the aircraft) for each subset of points. Advantageously, to determine the value of the characteristic for each subset of points, the various points of each subset of points are ordered in the order of the timestamping of the information from the database. For the first subset of points, given that the latitude corresponding to point 8 is greater than the latitude corresponding to point 12, the path is oriented from North to South, and therefore the value of the heading is equal to 180°. For the second subset of points, given that the latitude corresponding to point 9 is less than the latitude corresponding to point 10, the path is oriented from South to North, and therefore the value of the heading is equal to 0°. For the third subset of points, given that the latitude corresponding to point 12 is greater than the latitude corresponding to point 13, the path is oriented from North to South, and therefore the value of the heading is equal to 180°. In step E5, the processing unit determines a value of the characteristic for the interval of points based on the values of the characteristic that are determined for each subset of points, that is to say, 180°, 0° and 180°. Since these values are numerical, the value of the characteristic for the interval of points corresponds, for example, to a median of the values of the characteristic that are determined for each subset of points. The median value is then equal to 180°. The method according to the invention thus makes it possible to determine a correct value of the characteristic despite the problem with the timestamping of the information contained in the database 12. Advantageously, in a step E6, the computer 14 transmits the value of the characteristic thus determined to the user device 18.

In one particular embodiment, the method according to the invention furthermore comprises a step E7 of determining a confidence indicator associated with the value of the characteristic determined for the interval of points. In one particular example, this confidence indicator is calculated using the following formula:
I = N / k
in which:
I is the indicator;
k is the first predetermined number; and
N corresponds to a number of values of the characteristic that are determined in step E4 for the various subsets of points, such that a difference between each of the values and the value of the characteristic determined in step E5 is less, in terms of absolute value, than a predetermined threshold if the values are numerical, or such that these values are identical to the value of the characteristic determined in step E5 if the values are non-numerical.

The value of the indicator I is between 0.5 and 1. The confidence indicator is better the closer its value is to 1.

In the particular case of the abovementioned example, with the values determined in step E4 for the three subsets of points being equal to 180°, 0° and 180° and the value determined in step E5 being equal to 180°, considering a predetermined threshold of 10°, the number N is equal to 2, and therefore the indicator I is equal to:

I = 2 / 3 ≈ 0.67.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems for detecting skew in a wing slat of an aircraft described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for determining a characteristic associated with a portion of a path of an aircraft, the method comprising the following step, implemented by a processing unit of a computer:
acquiring, from a database, timestamped information relating to points of a path of the aircraft;
selecting, from among the points of the path corresponding to the information acquired from the database, an interval of successive points of the path of the aircraft, this interval of points corresponding to said portion of the path;
selecting a first predetermined number of subsets of points belonging to the interval of points, these subsets being mutually different, each subset of points comprising a second predetermined number of points, the first predetermined number being greater than or equal to three and the second predetermined number corresponding to a number of points needed and sufficient to determine said characteristic;
determining a value of said characteristic for each subset of points;
determining a value of the characteristic for the interval of points, based on the values of the characteristic that are determined for each subset of points.

2. The method as claimed in claim 1, wherein the interval of successive points comprises the following points:
a first set of points comprising a number of points equal to the second predetermined number of points, including a point of interest of the path for which it is desired to determine said characteristic;
a third predetermined number of points before the first set of points in an order of the timestamping of the information from the database; and
a fourth predetermined number of points after the first set of points in the order of the timestamping of the information from the database.

3. The method as claimed in claim 2, wherein the third predetermined number of points and the fourth predetermined number of points are equal.

4. The method as claimed in claim 1, wherein various points of the interval of points correspond to consecutive points in an order of the timestamping of the information from the database.

5. The method as claimed in claim 1, wherein, to determine the value of said characteristic for each subset of points, various points of each subset of points are ordered in an order of the timestamping of the information from the database.

6. The method as claimed in claim 1, wherein various points of each subset of points are selected from among the points belonging to the interval of points by implementing a pseudo-random draw algorithm.

7. The method as claimed in claim 1, wherein various points of each subset of points are selected in a predetermined manner from among the points belonging to the interval of points.

8. The method as claimed in claim 1, wherein the characteristic is chosen from among the following set of features:
a characteristic relating to an attitude or to a position of the aircraft, or to variations in an attitude or in a position of the aircraft;
a characteristic relating to an evolution of the aircraft in its environment;
a characteristic relating to a maneuver of the aircraft;
a characteristic derived from the above characteristics.

9. The method as claimed in claim 1, wherein the value of the characteristic for the interval of points is determined as corresponding to:
a median of the values of the characteristic that are determined for each subset of points, when the characteristic is numerical; or
a majority vote from among the values of the characteristic that are determined for each subset of points, when the characteristic is non-numerical.

10. The method as claimed in claim 1, furthermore comprising a step of determining a confidence indicator associated with the value of the characteristic determined for the interval of points.
